(19) United States
(12) Patent Application Publication
(10) Pub. No.: US 2021/0245015 A1
(43) Pub. Date: Aug. 12, 2021

(54) Sports Ball Sensor Suspended in Low Density Foam Insert

(71) Applicant: Hugh Linton tompkins, IV, Seattle, WA (US)

(72) Inventor: Hugh Linton tompkins, IV, Seattle, WA (US)

(21) Appl. No.: 17/169,463

(22) Filed: Feb. 7, 2021

Related U.S. Application Data
(60) Provisional application No. 62/970,927, filed on Feb. 6, 2020.

(51) Int. Cl. A63B 43/00; A63B 41/02; A63B 37/12; A01K 15/02

(52) U.S. Cl. CPC A63B 43/004; A63B 41/02; A63B 37/12; A63B 2225/50; A63B 2209/00; A63B 2220/51; A01K 15/025

(57) ABSTRACT

One embodiment of sport ball sensor suspended in low density foam insert allows for a smart ball to be made with performance matching a traditional ball without any means of sensing. The ball can be made at a lower cost than current balls with sensors, and will have lower rates of air leakage due to the method of inserting the sensor through the air valve orifice.

### CROSS-REFERENCE TO RELATED APPLICATION

This application claims the benefit of provisional patent application Ser. No. 62/970,927, filed 2020 Feb. 6 by the present inventor.

### BACKGROUND—PRIOR ART

### US Patent

Patent Number: U.S. Pat. No. 10,765,925B2

Increasingly, sensors are being placed in sports balls and other ball-like toys and sport projectiles. These sensors are gathering information about the motion, physics and performance of the equipment and are used by the athletes, coaches and trainers (as well as the companies producing the equipment) to inform training and provide feedback on the performance of the athlete, as well as to provide data during game-play such as when a ball is out of bounds. There is also an entertainment component to this data, as spectators could be shown specific details from the game such as the speed of a throw. Companies also have a use for the data as it relates to customer behavior.

Currently there are multiple ways in which manufacturers are adding sensors to a ball's construction. The goal of adding any sensor to a ball, beyond the obvious need to be able to gather data, is to affect the ball's play as little as possible. If a basketball with a sensor does not bounce as consistently as a basketball without a sensor, it is likely to be rejected by coaches and players. The challenges are that sensors are a mass that is not present in a traditional ball. Where you locate that mass is also problematic, since an inflated ball has no material beyond its outer layers on which to mount a sensor.

Beyond where and how the sensor is mounted, there are also typically changes made to the ball's bladder to accommodate the insertion of the sensor. The bladder is responsible for the ball's air retention, and changes to its construction can have an effect on its ability to hold air.

In addition to performance athletic balls, the ever-decreasing price of components means sensors are being placed I less serious balls as well. Toys and pet products with sensors can provide fun and other benefits, but also have obstacles to overcome. Predictable motion and safety are among the serious considerations for customers of these types of balls with sensors. Toys must insure that the sensor doesn't create a hard spot on the ball that could hurt a child during play.

### SHORTCOMINGS OF CURRENT METHODS

Most of the current methods involve placing the sensor on the perimeter of the ball (vs. the center). The resulting imbalance in weight is usually addressed by placing counterweights opposite of the sensor. This can work for some ball types and can result in a ball whose slight imbalance isn't detectable by most players. However, additional problems arise when the ball type is one that is bounced or struck as a part of gameplay. Examples are basketball, volleyball and soccer. For these ball types, the ball can display unexpected kinematics if it bounces or is struck on or near the sensor. This is a result of the different density and material type at the sensor versus away from the sensor, as well as the extra forces the sensor's mass exerts on the ball as it moves during the ball's deformation and restitution during the impact. Neither of these two problems can be solved with counterweights.

Placing sensors in the center of the ball can potentially solve this issue, but also presents its own challenges. In addition to being more difficult to produce and costly, the solution must find a way to suspend the sensor in the open space in the center of the ball. Current solutions require multiple anchor points on the perimeter of the ball, which can also cause the same unexpected ball performance as designs with the sensor on the perimeter.

Another problem with placing sensors in sport balls is that they often require the ball's bladder production to deviate from the traditional method. The ball's bladder is the component of the ball that is responsible for holding air, and its ability to keep air (air retention) is compromised with any new orifices made in it beyond the single orifice for the air valve. Most methods for placing a sensor inside a sport ball require at least a second orifice to be cut into the bladder material during production, introducing the opportunity for increased defect rates due to leaking.

The last problem that all these methods face is increased production cost. Beyond the cost of the sensor and extra components, there is typically a significant increase in the manufacturing costs to implement them in production. This is due to the complex and unorthodox bladder constructions which often require unique equipment and techniques.

### SUMMARY

In accordance with one embodiment, a ball with a sensor suspended at its geometric center and suspended in a low density, open-cell foam such that the foam has no material impact on the ball's motion and feel during play. Further, the ability of the foam to compress to a very small size allows the foam insert and sensor to be introduced to the ball's interior through the existing bladder hole, requiring no unorthodox bladder constructions.

### ADVANTAGES

Accordingly, several advantages of one or more aspects are as follows:
(a) The low density, light weight foam doesn't dampen the ball's deformation or restitution when struck or bounced. This can't be said for other methods, which require dense rubber where the sensor attaches to the ball's perimeter. These dense materials, along with the heavy sensor on the perimeter of the ball, have high mass and create inertia during deformation and restitution that affect the ball's motion negatively.
(b) All foreign mass, in other words, mass that doesn't exist in ball's without sensors, is symmetric and concentric in the sphere of the ball. This allows the ball or object to display the balance, symmetry and trueness-of-play previously only achievable with a non-sensor ball.
(c) By using a traditional bladder with only one orifice, the foam insert greatly increase air retention over other solutions that cut multiple holes in the bladder.
(d) By using a traditional bladder and inserting the foam and sensor into the ball's interior through the existing fill hole, production costs are greatly reduced.
Other advantages of one or more aspects will be apparent from a consideration of the drawings and ensuing description.

### DRAWINGS—FIGURES

FIG. 1a is a perspective view of the first embodiment, an inflatable sports ball with a structural carcass and a foam-suspended sensor.

FIG. 1b is a perspective view of the first embodiment and indicates section lines for FIG. 1d.

FIG. 1c is a top view of the first embodiment and indicates section lines for FIG. 1d.

FIG. 1d is a section view of the first embodiment.

FIG. 1e is a section view of the first embodiment and indicates the location of closeup 1f.

FIG. 1f is a closeup of the sensor and tough coating.

FIG. 1g is a section view of the first embodiment and indicates the location of closeup 1h.

FIG. 1h is a closeup of the air-valve area of the ball in the first embodiment.

FIG. 2a is a perspective view of the sensor and tough coating and indicates the section lines for FIG. 2b.

FIG. 2b is a section view of the sensor and tough coating.

FIG. 3a is a perspective view of the insertion tube.

FIG. 3b is a top view of the insertion tube and indicates the section lines for FIG. 3c.

FIG. 3c is a section view of the insertion tube.

FIG. 4a is a perspective view of the plunger.

FIG. 4b is a top view of the plunger and indicates the section lines for FIG. 4c.

FIG. 5a is a top view of the foam insert with sensor and tough coating and indicates the section lines for FIG. 5b.

FIG. 6a is a section view of the foam insert and the insertion tube.

FIG. 6b is a section view of the foam insert 50% loaded into the insertion tube.

FIG. 6c is a section view of the foam insert fully loaded into the insertion tube.

FIG. 7a is a section view of a ball carcass with the air valve and carcass patch removed, and indicates the area of close up 7b.

FIG. 7b is a closeup section view of the air valve housing.

FIG. 8a is a section view of ball carcass 7a and loaded insertion tube 6c.

FIG. 8b is a section view of ball carcass 7a and loaded insertion tube 6c 50% inserted.

FIG. 8c is a section view of ball carcass 7a, loaded insertion tube 6c fully inserted, and plunger 4a.

FIG. 8d is a section view of ball carcass 7a, loaded insertion tube 6c, and plunger 4a 50% inserted.

FIG. 8e is a section view of ball carcass 7a with foam insert 5a fully installed, and plunger 4a full retracted.

### DRAWINGS—REFERENCE NUMERALS

110 Carcass Patch

111 Orifice

120 Air Valve Housing

130 Air Valve

140 Bladder

150 Carcass

160 Low Density Foam

170 Tough Coating

180 Sensor

810 Stretched Air Valve Housing

820 Stretched Bladder Orifice

### DETAILED DESCRIPTION

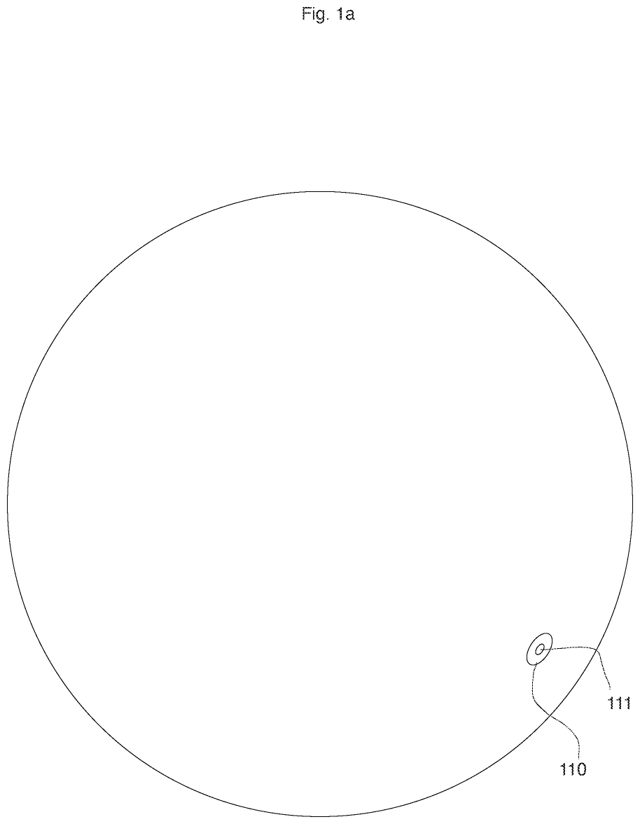

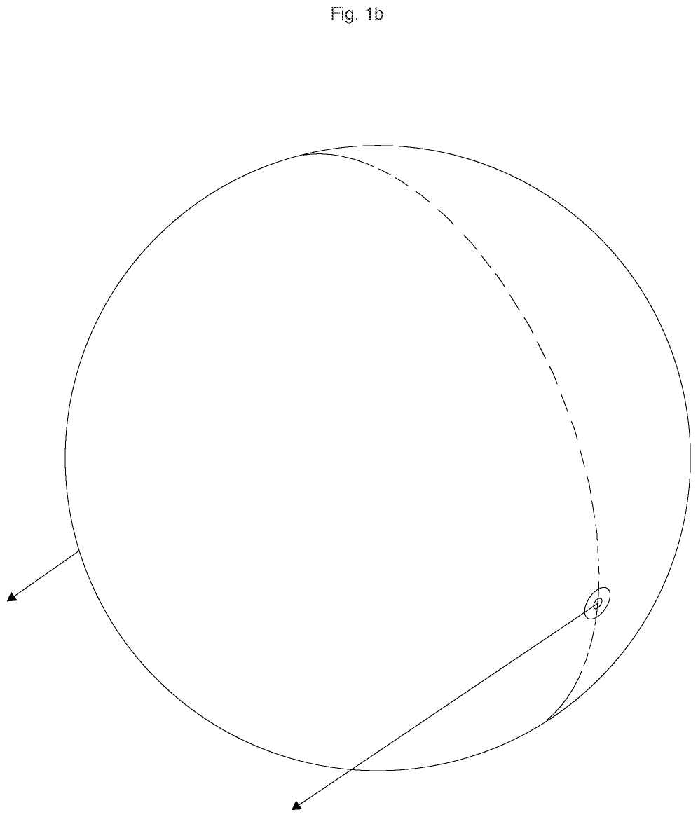

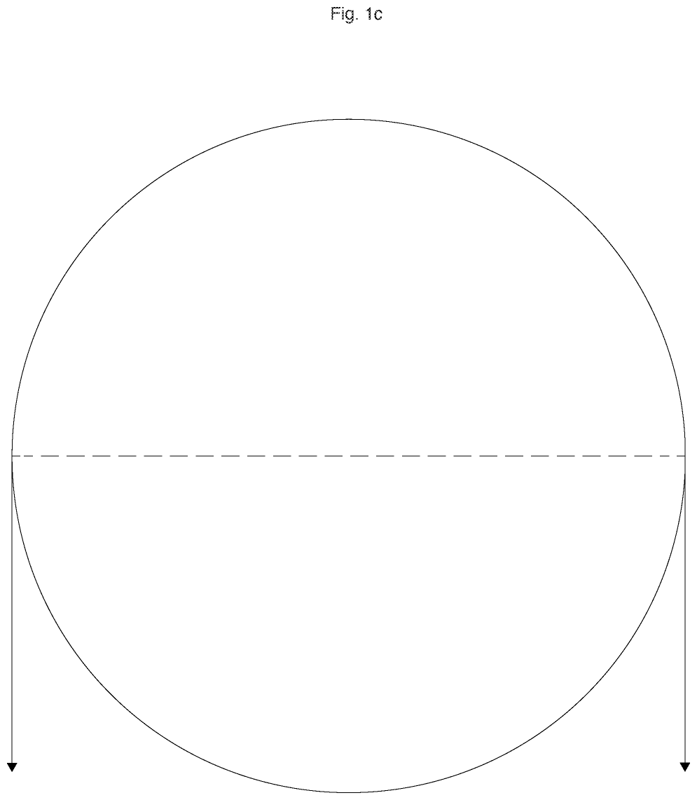

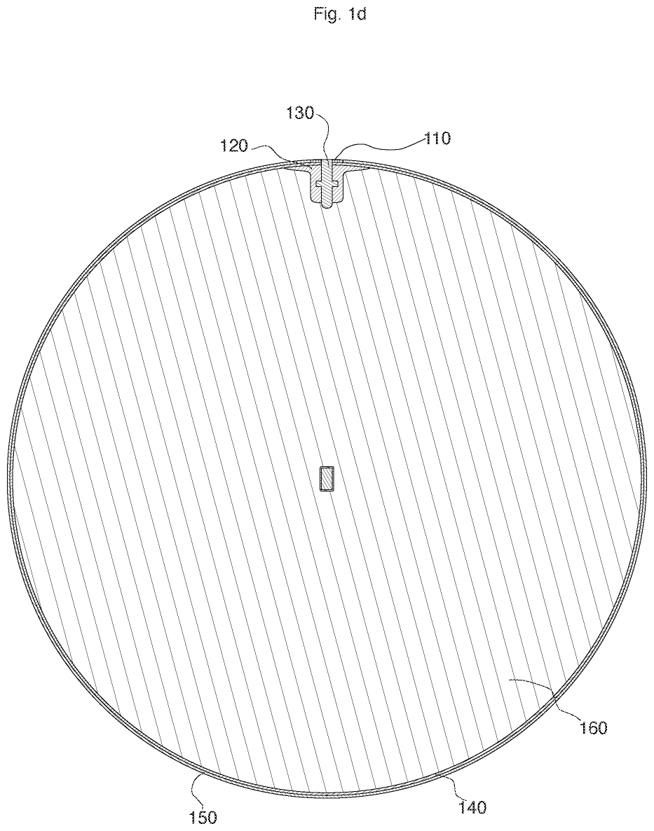

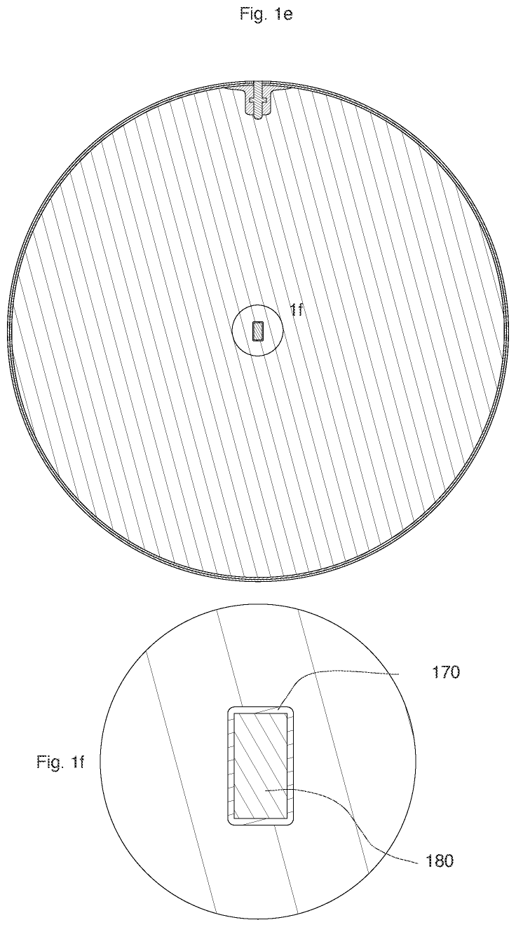

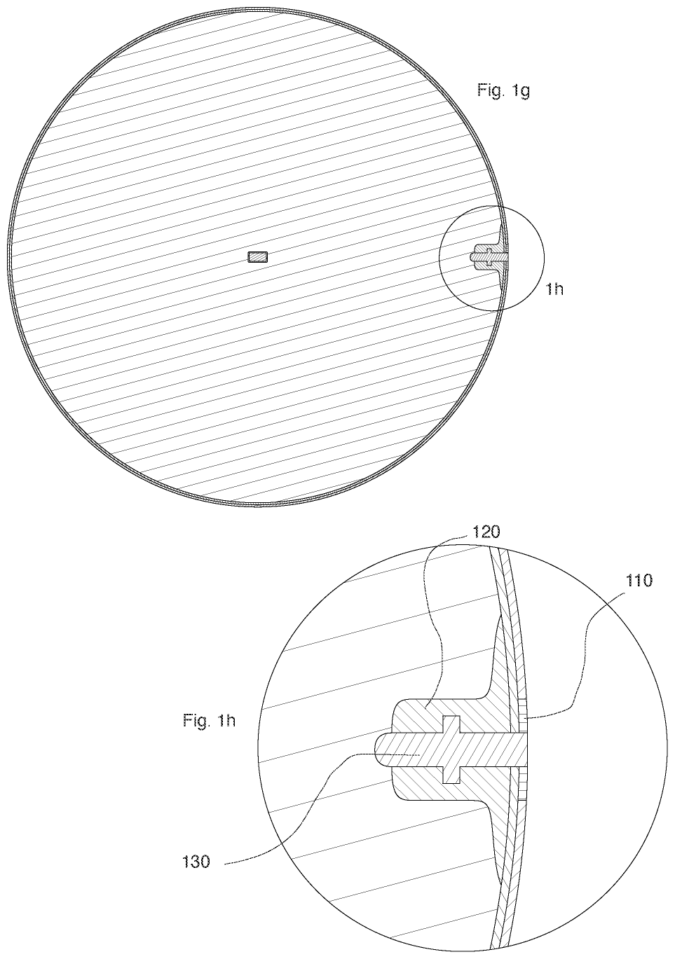

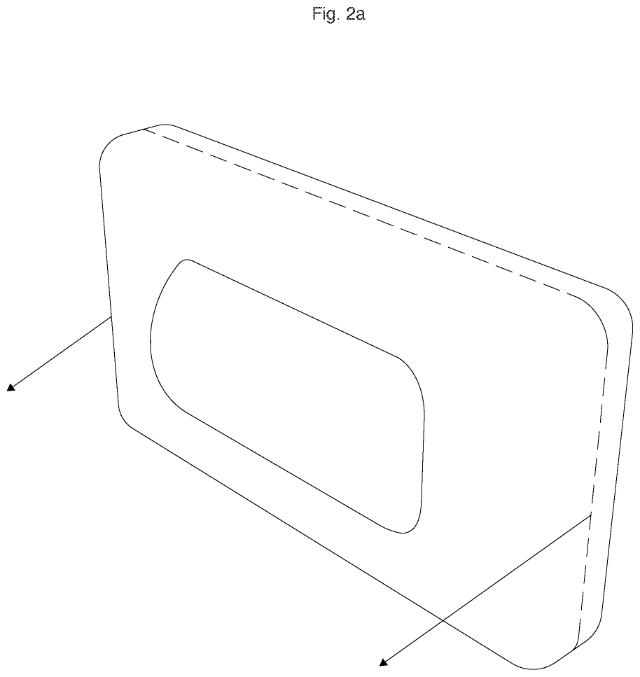

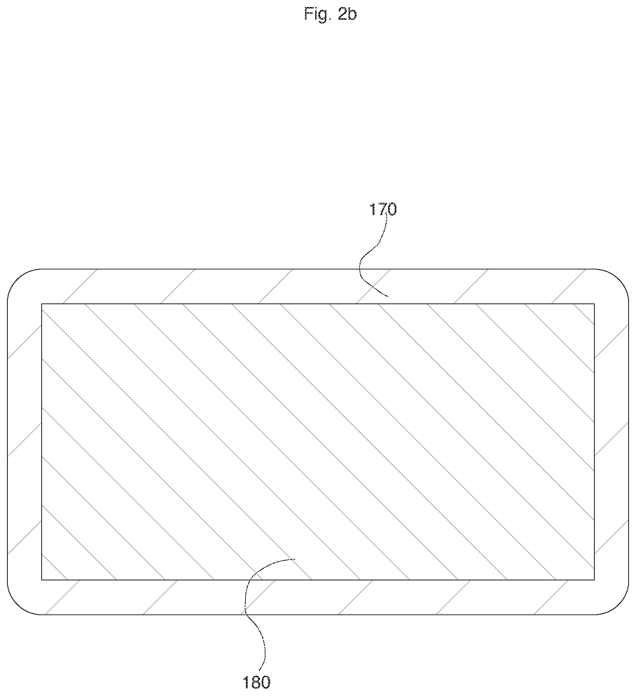

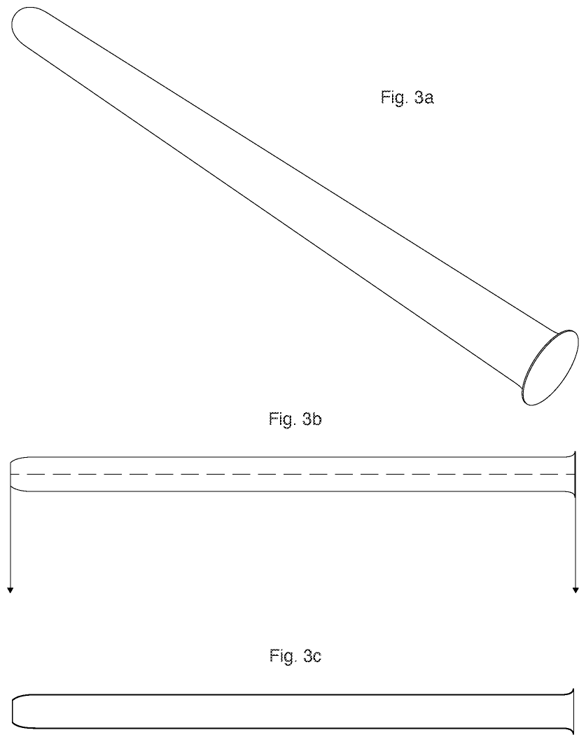

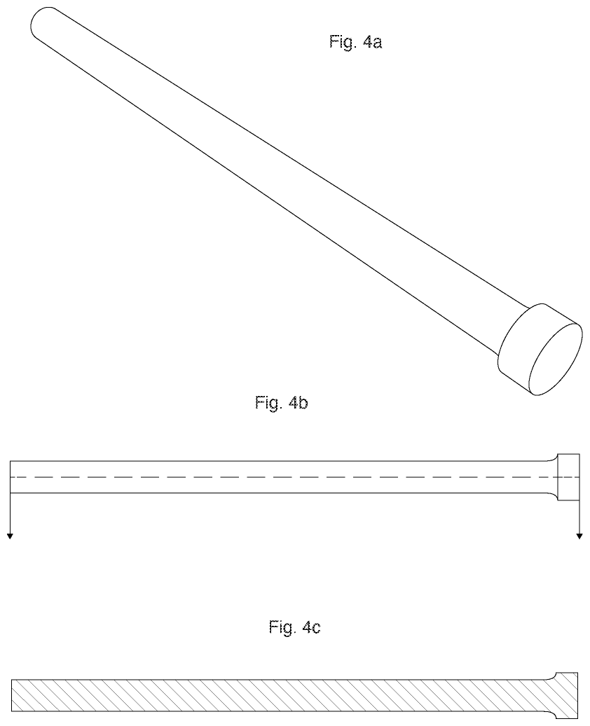

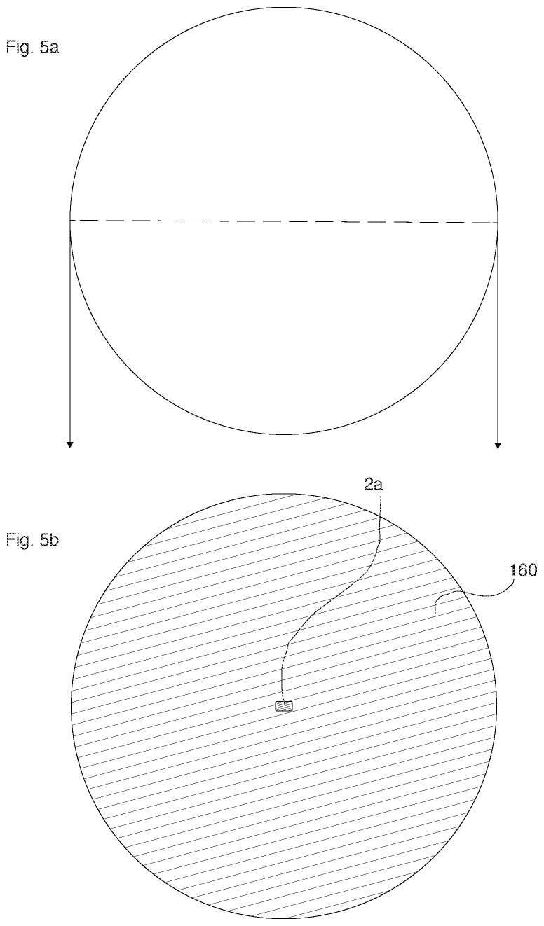

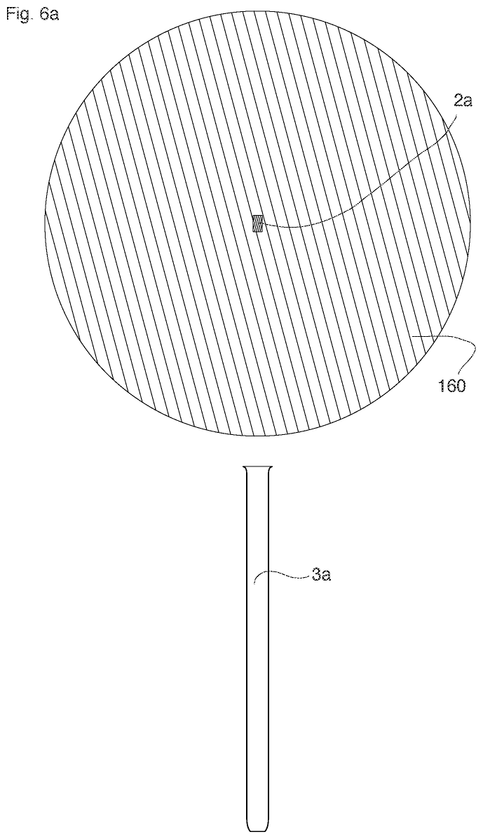

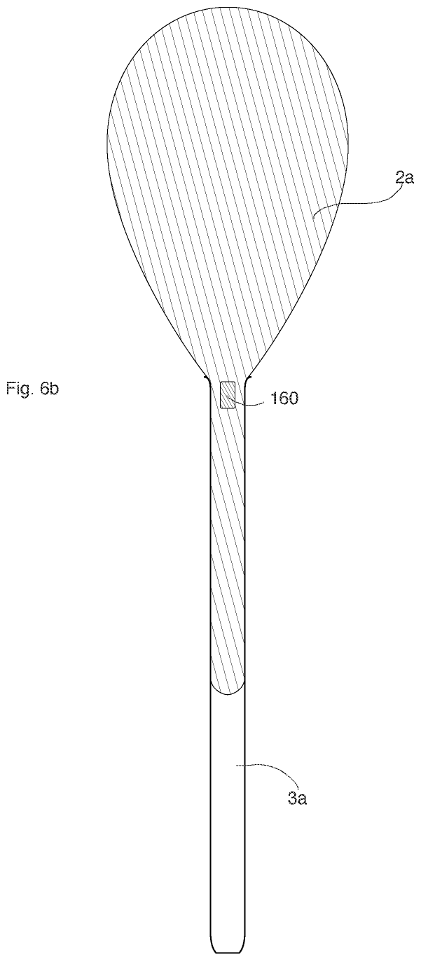

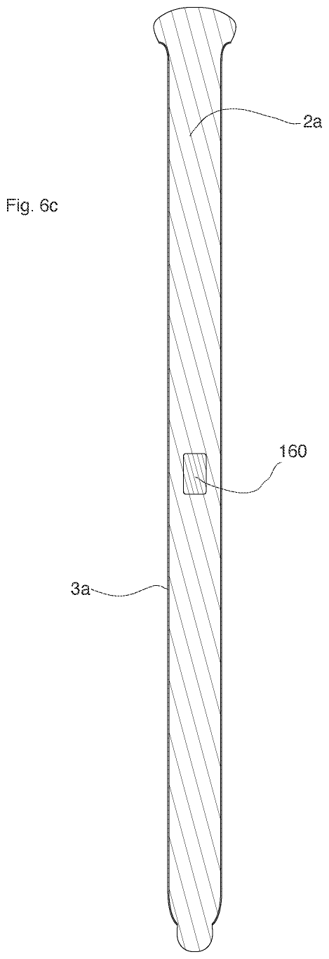

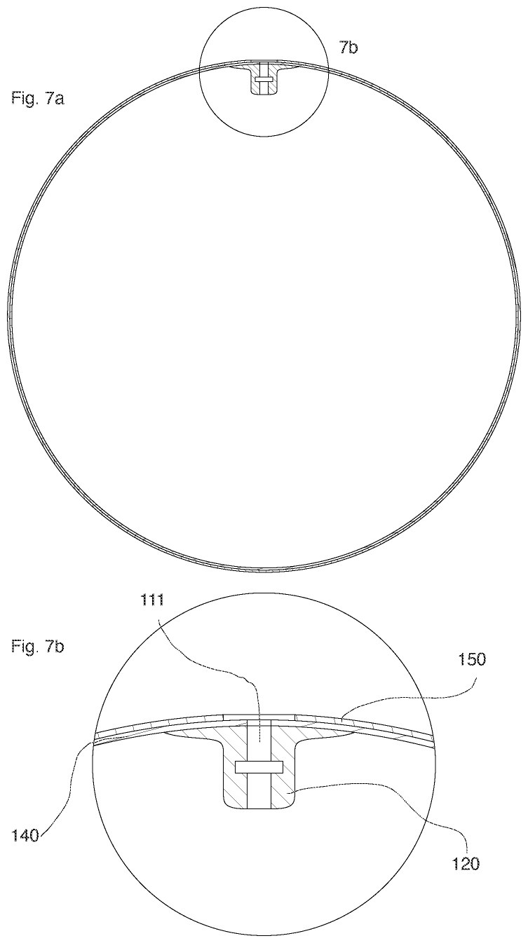

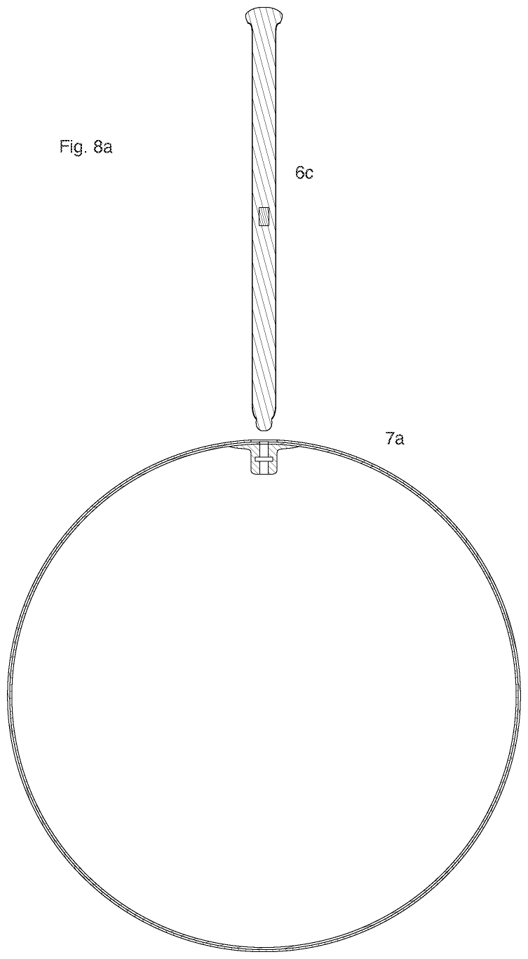

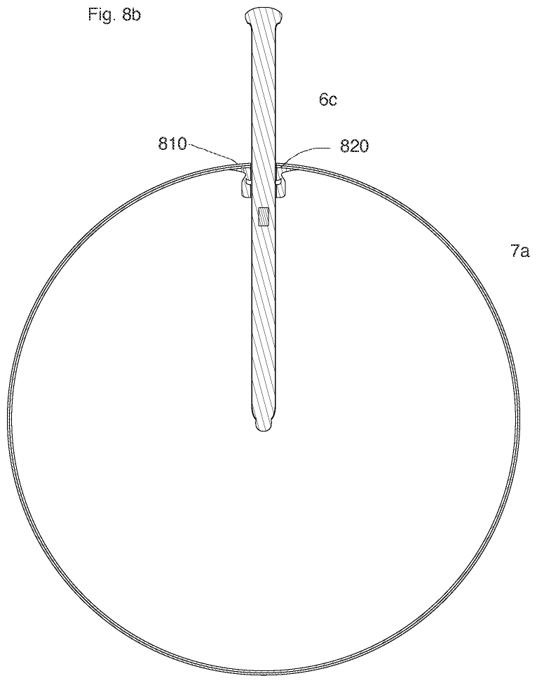

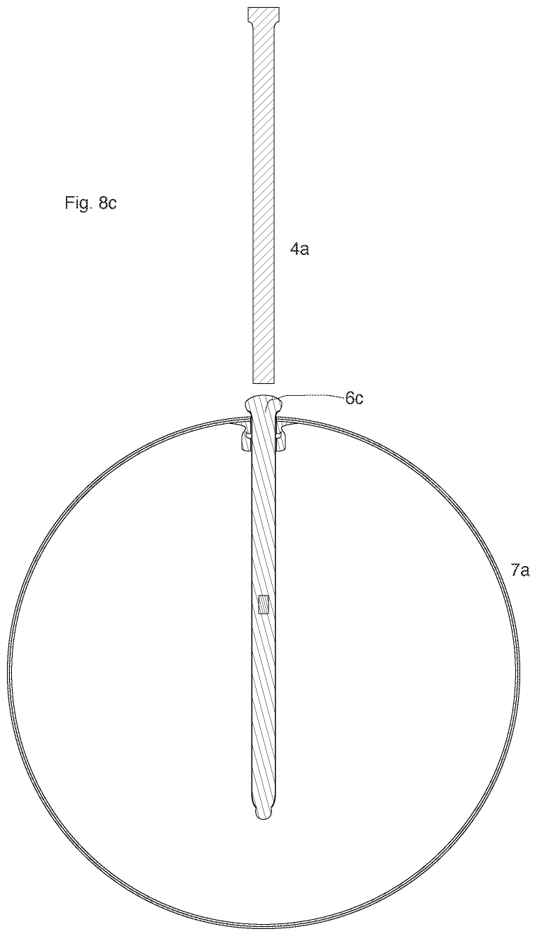

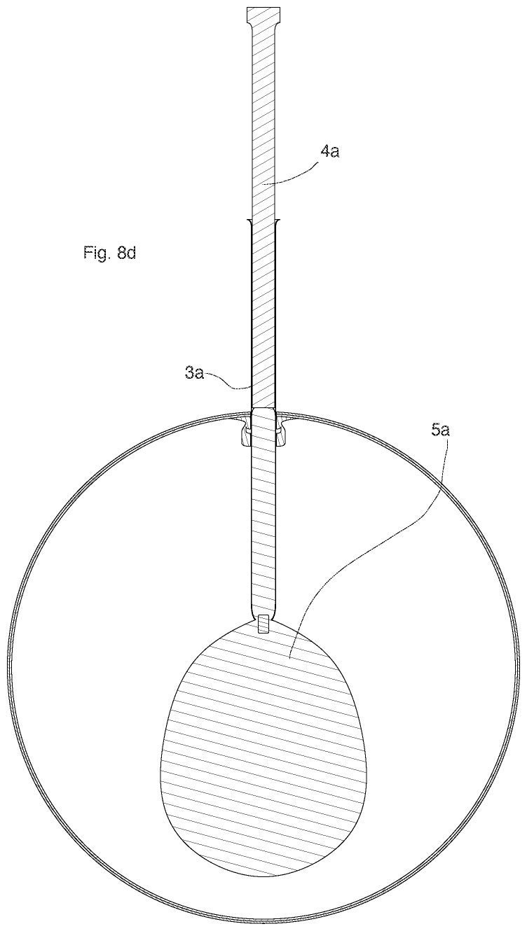

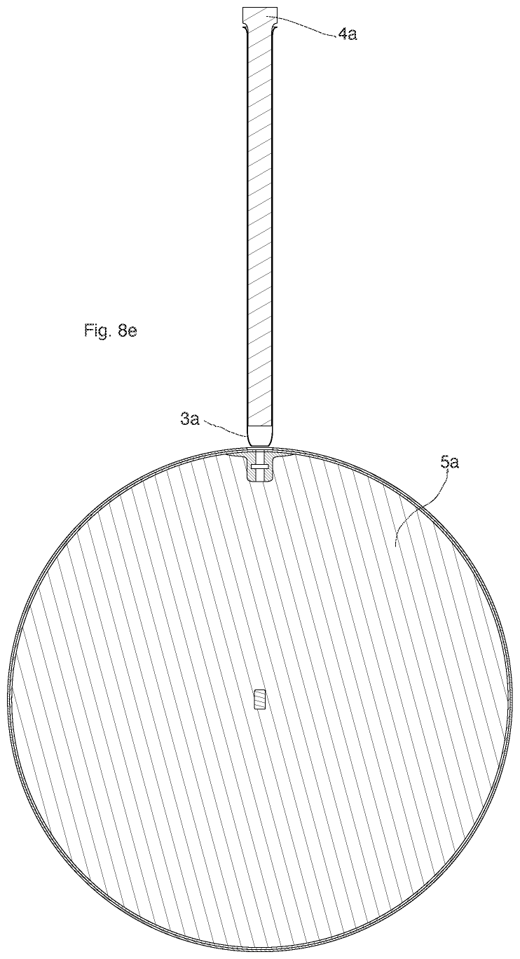

### FIG. 1a-8e—First Embodiments

One embodiment of the ball sensor in foam insert is illustrated in FIG. 1a-8e. In this embodiment, a sensor with means to detect and transmit data is suspended in a low density, open cell foam in the geometric center of the ball. The sensor is additionally encased in a tough coating that protects its delicate components. The sensor can measure a wide variety of physical forces, be powered with a number of different sources, and can be of different size and shapes, as long as it is small enough to fit through the stretched-open orifice in the bladder. The foam can be made of a wide variety of materials, but should be of adequately low density so as to be compressible enough to fit through the stretched-open orifice in the bladder. The foam must also be open cell to allow for inflation, and the compressions and restitution a ball can experience when used. The sensor coating can be made of a wide variety of materials and durometers.

In this embodiment, the ball has a carcass 150 make up its exterior layers. Beneath that, a bladder 140.

Filling the interior space created by the bladder is a foam 160.

In the geometric center of the ball, a sensor 180 is encased in a tough coating 170.

At one location in the bladder 140 and the carcass 150 is an orifice 111.

Affixed to the interior surface of the bladder 140 and around the orifice 111 is a air valve housing 120.

The air valve housing 110 seats an air valve 130.

The orifice 111 in the carcass 150 is cut larger than the orifice 111 in the bladder 140.

The delta in orifice size in the bladder 140 and the carcass 150 is closed by a carcass patch 110.

Operation—FIG. 1a-8e

The means of assembling and using the sport ball with foam insert starts by producing a ball bladder 140 through traditional means. The ball's carcass 150 is also made through standard techniques with the exception being that orifice 111 for the air valve is cut larger than orifice 111 in the bladder. Ball carcasses are made with components with high tensile strength such as nylon windings. These materials allow the ball to be pressurized while maintaining a set diameter. However, they cannot stretch like a bladder, so the carcass orifice 111 must be adequately large to allow the sensor 2a and foam 160 to pass through. The air valve housing 120 is affixed to bladder 140 using standard techniques. Once the ball is produced with a bladder, carcass and air valve housing, the foam insert 5a is ready to be installed.

The foam insert 5a is compressed and fed into the insertion tube 3a. The insertion tube 3a is made of a ridged, thin material capable of withstanding the compressive forces of the stretched air valve housing 810 and the stretched bladder 820, as well as the pressure of pressing the insertion tube 3a into the ball's interior. Once foam insert 5a is fed into insertion tube 3a, assembly 6c is ready to be inserted into the ball.

Assembly 6c is pressed into orifice 111, stretching the valve housing 810 and bladder 820 to accommodate. Assembly 6c presses into the ball until the flared end is pressed against the ball's exterior.

The plunger 4a fits into the interior of insertion tube 3a and is used to push assembly 6c out of the insertion tube and into the ball's interior. With assembly 6c fully inserted into the ball, plunger 4a is pressed into the open end of the insertion tube 3a. As the plunger 4a is pressed in, insertion tube 3a is simultaneously pulled out of the ball. This results in assembly 6c being ejected into the ball's interior. Once insertion tube 3a is fully removed from the ball, and plunger 4a is fully pressed into the insertion tube 3a, the foam insert 5a is now installed.

With the foam insert in the ball, the gap between the bladder orifice and carcass orifice must be filled with the carcass cap 110. This not only makes the surface of the ball smooth, but it also adds tensile strength to the area of exposed bladder.

The last step is to insert air valve 130 into air valve housing 120 using standard techniques.

With the minor acceptation of the carcass cap 110, all the components that make up the perimeter of the ball are identical to those of a traditional sports ball. The low density foam 160 easily compresses and expands with the ball as it is struck and bounced, keeping the sensor 180 in the geometric center. Without the mass of sensor 180 and tough coating 170 on the perimeter of the ball, their weight and inertia have a negligible effect on the ball's motion and performance. The open cell nature of the foam 160 allows the ball to be inflated with standard means, and can compress and expand without dampening.

### Additional Embodiment

One additional embodiment involves adding a bitter flavor to the foam 160. If the ball construction were intended for a pet, the bitter flavor would add a deterrent layer to keep an animal from chewing through to the sensor 180.

One additional embodiment utilizes an inert material for tough coating 170. In this embodiment, if a pet or child were to penetrate into the ball's interior and gain access to the sensor and coating 2a, it would do no harm to them if swallowed.

### Advantages

From the description above, a number of advantages of some embodiments of the sport ball sensor in foam
(a) Balls for sport, toy, or pet that contain sensors can enjoy the same high level of performance as a traditional ball or toy.
(b) Balls with sensors can be made for much less than the current state of the art
(c) Balls with sensor can be made to be much more durable since they do not possess multiple holes in their bladder.

### CONCLUSIONS, RAMIFICATIONS, AND SCOPE

Accordingly, the reader will see that the sport ball sensor suspended in foam of various embodiments can be used to improve the performance of balls with sensor, reduce the cost of producing the balls, improve the air retention of the balls and make them safer for pets and children.

Although the description above contains many specificities, these should not be construed as limiting the scope of the embodiments but as merely providing illustrations of some of the several embodiments. For example, the foam insert with sensor could be utilized with similar benefit in objects that aren't balls, such as flying disks or boomerangs. The tough coating could exist on its own without being suspended in foam if it were instead suspended in a ball made of a solid substrate.

Thus, the scope of the embodiments should be determined by the appended claims and their legal equivalents, rather than by the examples given.

What is claimed is:

1. A device capable of sensing and measuring physical forces and transmitting the data to a secondary device, held in the geometric center of an inflatable ball for sports, suspended in low density, open-cell foam where:
a) the device and foam were fed into the ball's bladder through the air valve orifice, and
b) there are no secondary orifices in the bladder, and
c) no secondary orifices are created in the bladder at any point in manufacture, and
d) the low density foam fills the full interior of the ball, and
e) the device is encased in a tough coating.

2. The device of claim 1 wherein said low density foam is infused with a bitter flavor to discourage chewing in animals.

3. The device of claim 1 wherein said tough coating is inert and safe to swallow by humans or animals.

4. A device capable of sensing and measuring physical forces and transmitting the data to a secondary device, held in the geometric center of a solid ball for sport, pet or toy where:
a) the device is coated in a tough coating, and
b) the device is at the geometric center of the solid ball.

5. The device of claim 4 wherein the tough coating is inert and safe to swallow by humans or animals.
